(19) United States
(12) Patent Application Publication
(10) Pub. No.: US 2005/0232563 A1
(43) Pub. Date: Oct. 20, 2005

(54) Method for producing an optical waveguide and said optical waveguide

(75) Inventor: Jochen Kunze, Moers (DE)

Correspondence Address: WARN, HOFFMANN, MILLER & LALONE, .P.C, PO BOX 70098, ROCHESTER HILLS, MI, 48307, US

(73) Assignee: G.L.I. Global Light Industries GmbH, Kamp-Lintfort (DE)

(21) Appl. No.: 11/107,251

(22) Filed: Apr. 15, 2005

(30) Foreign Application Priority Data
Apr. 16, 2004 (DE) DE102004020809.3

(51) Int. Cl. G02B 6/10

(52) U.S. Cl. 385/129; 385/14

(57) ABSTRACT

The invention concerns a method for producing an optical waveguide from a material which is flowable before final solidification, in a mold, wherein, on a first introduction of the flowable material at least one radiation-emitting emitter with its connecting means electrically contacting the emitter is surrounded by said material, and one or more additional introductions of one or more flowable materials take place in regions located outside the regions of the emitter and the connecting means. It is proposed that a coating material is monolithically joined to the optical waveguide during at least one of the introductions. The invention further concerns an optical waveguide.

### CROSS-REFERENCE TO RELATED APPLICATIONS

This application claims priority to German Patent Application No. DE 10 2004 020 809.3 filed on Apr. 16, 2004.

### BACKGROUND

The invention involves a method for producing an optical waveguide and also involves an optical waveguide according to the preambles of the independent claims.

Known from DE 101 63 117 C1 is a method for producing light-emitting diodes (LEDs) in which virtually all light-emitting diodes produced have the same optical properties, and rejects due to damage to the individual LED electronics are avoided. An optical waveguide is produced from a material which is flowable before final solidification, in a mold, wherein, on the first introduction of the material at least one light-emitting chip with its connecting means electrically contacting the chip are surrounded by the material, and one or more additional introductions of one or more flowable materials take place in regions located outside the chip and the connecting means. A lateral surface of the light-guiding LED body may be galvanically metallized as an additional reflector. However, this requires additional process effort for the galvanic coating and structuring of the light-guiding LED body.

The object of the invention is to further develop the method of the generic type for producing optical waveguides such that a coating process is simplified. A further object is to produce optical waveguides that have a coating at least in part, wherein the coating has high optical quality.

The objects are attained according to the invention by the features of the independent claims. Additional embodiments and advantages of the invention are disclosed in the additional claims and in the description.

### SUMMARY OF THE INVENTION

The inventive method for producing an optical waveguide provides that a coating consisting of a coating material is monolithically integrated with the optical waveguide during at least one introduction of a material which is flowable before final solidification, where the optical waveguide is made of said material at least in some regions. “Monolithically integrated” should be understood to mean, in particular, that the coating is brought into contact with the flowable material and is joined to the body for which it is to be the coating during the formation of that body, in particular at its solidification. It is advantageous that an additional coating step for applying a coating that is reflective for the electromagnetic radiation emitted by an emitter of the optical waveguide can be omitted. A special surface treatment, such as for improving the adhesion of the coating, is eliminated. The coating, especially at a boundary surface of the optical waveguide, can take place in a single process step together with the production of the optical waveguide. In addition, the coating has the requisite quality for optical components. In particular, an LED with such an optical waveguide can provide high luminous efficiency.

Depending on the material used, the electromagnetic radiation of the emitter can lie in the optical range or in the ultraviolet or infrared range. Wherever it is used, the term “light” should be understood to always mean electromagnetic radiation, which may also lie outside the visible wavelength range. In particular, the emitter is a non-glow-discharge emitter.

A semiconductor chip comprising the emitter can be electrically contacted by means of one or more bond wires, or can also be contacted through bond surfaces on a chip carrier with appropriately designed electrical contact surfaces, for example in the case of so-called chip-on-board modules. In addition to conventional LED materials, such as III-V semiconductors or IV-VI semiconductors, any other non-glow-discharge emitter may also be used as the material for the emitter. Moreover, coatings which have specific functionalities may be provided for the optical waveguide. The coating may be transparent, semi-transparent, or nontransparent, in particular reflective, with respect to the emitted radiation. In like manner, different types of coatings may be provided on an optical waveguide. The coating may represent an additional design element, for example be pigmented, in order to identify a characteristic property, such as e.g. the emission wavelength of the LED, or be used for integration in a light module in an assembly environment with predefined design requirements. Specific regions of the radiation emerging from the optical waveguide in a direction of propagation may be selectively shaded. By means of such shading it is possible, for example, to achieve a sharp transition from an area illuminated by the light module to an area that receives no emitted light, in much the same fashion as a predefined illumination characteristic of a front headlight of a motor vehicle; a comparable shading with conventional means in a front headlight is referred to in that context as “cut-off.”

It is especially preferred to use as a coating a film which can be metallized and/or provided with additives, especially phosphorescent materials, which function according to the principle of luminescence conversion. Such materials are optically excited by the radiation emitted by the emitter, and themselves emit radiation in another wavelength range. Radiation then emerges from the optical waveguide that is a mixture of the radiation emitted by the emitter and by the luminescence-converting additive. In the optical range, an LED coated in this manner, for example with an emitter that emits blue light and a coating that contains a cerium-doped yttrium-aluminum garnet (YAG:Ce), can radiate white light. YAG:Ce is optically excited by the blue radiation and emits yellow light, resulting overall in a white emission from the LED. Other types of organic or inorganic additives can also be provided, which are excited by the radiation emitted by the emitter and emit radiation in a different wavelength range.

In advantageous fashion, a film material of polycarbonate (PC), polypropylene (PP), polyvinyl chloride (PVC), acrylonitrile-butadiene-styrene copolymer (ABS), epoxide, polymethyl methacrylate (PMMA) and/or polystyrene (PS) is used. Plastic films can be employed with great advantage for this application. The use of silicone or a material containing silicone is especially preferred for such a film. This material is advantageous because of its heat resistance and its elasticity. A film of this material can conform especially well to a domed structure of a carrier.

Preferably a film is used that is very thin and can cling to the walls of the mold in which the optical waveguide is produced. A preferred thickness is a maximum of 100 μm, particularly a maximum of 50 μm, and especially preferred a maximum of 20 μm. If a film that is reflective in the optical wavelength range is desired, a metallized film or even a thin metal foil may be used.

Preferably the coating material is placed in a mold of a tool and is joined to the optical waveguide during at least one of the introductions of the flowable material or materials. The optical waveguide itself is produced in the mold with high surface quality adequate for optical requirements. The coating material is thus joined to the optical waveguide with a surface quality that meets optical requirements. In this regard, a casting process, such as for example an injection molding process or a potting process, may be used. A semiconductor chip may be monolithically integrated into an optical waveguide as the emitter, or an LED or a chip-on-board module with monolithically integrated primary optics may be used. In the case of such an LED or such a module, the emitter with its LED electronics is already surrounded by a light-guiding electronics casing.

In a preferred embodiment, the coating material is placed in a region of the mold in which is formed a part of the optical waveguide facing away from a primary direction of radiation emission of the optical waveguide. If the coating is reflective, a scattering loss in a region behind the emitter can be reduced and the luminous efficiency of the LED can be improved. If the coating material is additionally pigmented, this can serve as an easily recognizable identification of an LED property, for example the emission wavelength. Of course, a pigmented coating or transparent coating can also be used for this purpose.

In another preferred embodiment, the coating material is placed in a region of the mold in which is formed an essentially parallel part of the optical waveguide with respect to the primary direction of radiation emission of the optical waveguide. Here, too, if the coating material is reflective it is possible to avoid scattering loss and improve luminous efficiency.

In another preferred embodiment, the coating material is placed in a region of the mold in which at least part of the primary direction of radiation emission of the optical waveguide is formed. In this way, it is possible to achieve advantageous shadings of the radiation emerging from the LED or another modulation of the emerging radiation.

Of course, the embodiments described above may be used separately or in any desired combination with one another so that multiple coating materials—transparent, nontransparent, semi-transparent, reflective, pigmented and/or provided with luminescence-converting additives—may be provided on one optical waveguide and/or multiple regions of the optical waveguide may be provided with the coating or coatings.

An optical waveguide according to the invention has a coating with a coating material that is monolithically integrated in the optical waveguide. Preferably the coating is arranged in a part of the LED body facing away from a primary direction of radiation emission of the optical waveguide and/or in an essentially parallel part of the optical waveguide with respect to the primary direction of radiation emission of the optical waveguide and/or in at least one part of the primary direction of radiation emission of the optical waveguide.

In an advantageous further development, the coating is designed to be reflective toward the optical waveguide for a wavelength range of the radiation emitted by the LED or its emitters. Preferably the coating is designed to be impermeable for the wavelength range. In this way, it is possible to avoid intensity losses due to scattering. Essentially all the radiation emitted by the emitter is scattered, more particularly reflected or redirected, in the LED's primary direction of radiation emission, so the luminous efficiency is increased significantly.

In particular in the case of a non-glow-discharge light source in an optical waveguide, for example of a light-emitting diode or a chip-on-board module with primary optics or of an optical waveguide as secondary optics, such as, e.g., a light pipe or a light-guiding prism or a light-guiding lens, directing of the light is fundamentally dependent on physical effects of total reflection at a boundary surface, refraction at a boundary surface, or a mixture of the two effects. Total reflection of the light at a boundary surface in the optical waveguide, where the incident light beam falls below the threshold angle of total internal reflection—relative to the normal of the boundary surface—can only be achieved through an external reflective coating. This can be accomplished through the monolithic integration of a reflective coating in a simple and economical manner with respect to process technology.

In another advantageous further development, the coating is designed to be transparent for a wavelength range of the radiation emitted by the emitter of the LED. Preferably a luminescence-converting additive is provided in the coating so that a radiation emerging as a whole from the optical waveguide, through the coating, is a mixture of the radiation emitted by the emitter and by the additive.

Preferably the coating is embodied as a film. The film can be monolithically integrated directly with the optical waveguide, or an optical waveguide that is already monolithically integrated with the film can also be integrated into a new optical waveguide. Furthermore, provision is made in a favorable further development that the assembled optical waveguide thus formed can be subjected once more to a monolithic integration with additional material which is flowable before final solidification, so that the coating is located inside the optical waveguide as an inner boundary surface, and is no longer arranged on an external surface. In this way, the coating can be protected and/or purposeful influencing of the light propagation within the optical waveguide can be undertaken.

The optical waveguide can be provided with the coating or with multiple coatings in any desired way. Thus, in a favorable embodiment, a region facing away from the emitter may be provided with a reflective coating, while a transparent coating, which in particular contains luminescence-converting additives, may be provided in the primary direction of radiation emission, especially on a primary emergent surface. Furthermore, in addition or optionally, the exit optics can be provided in regions with reflective coating in the primary direction of radiation emission in order to shape the emergent radiation field in accordance with need, similar to the “cut-off” in a motor vehicle headlight. Moreover, a nontransparent, pigmented coating may additionally be provided in order to identify characteristic properties of the LED.

The invention can be applied to an extremely wide variety of types and forms of optical waveguides. Dimensioning of the optical waveguide depends solely on reasonable or necessary production-related limits imposed by the process of monolithic integration employed, such as injection molding methods or potting methods. In particular, the invention can be used in the manufacture of light-emitting diodes, chip-on-board modules, or other optical waveguides. This includes a reflective coating on at least one area of the optical waveguide as well as wavelength conversion in one or more regions of the optical waveguide.

Further advantages are evident from the description of the drawings below. The drawings show example embodiments of the invention. The drawings, the description, and the claims contain numerous features in combination. An individual who is skilled in the art will usefully also view the features individually and combine them in additional logical combinations.

### BRIEF DESCRIPTION OF THE DRAWINGS

FIG. 1, a cross-section through a mold with an optical waveguide and inserted coating material,

FIG. 2, a schematic representation of a cross-section through an optical waveguide with reflective coated region for one-sided intensification of the reflection,

FIG. 3, a parabolically molded LED with reflective coating,

FIG. 4, an elliptical LED with opaque coating to produce a precise demarcation between light and dark,

FIG. 5, an LED with transparent coating, which contains luminescence-converting additives, arranged on a radiating surface,

FIG. 6, an optical waveguide with lateral coating,

FIGS. 7a, b, a light module with a two-dimensional array of exit lenses with a coating between the exit lenses, shown in a sectional side view (a), and with paraboloidal projections (b),

FIGS. 8a, b, a light pipe with a sawtooth emergent surface (a) with opaque coating on its rear side (b),

FIGS. 9a, b, a light pipe with an emergent surface formed after the fact with an emergent surface twisted upon itself (a), and with a straight emergent surface (b),

FIG. 10, a light pipe with preformed coating, and

FIG. 11, an optical waveguide with high luminous efficiency and primary direction of radiation emission directed laterally out of the optical waveguide.

### DETAILED DESCRIPTION OF THE PREFERRED EMBODIMENTS

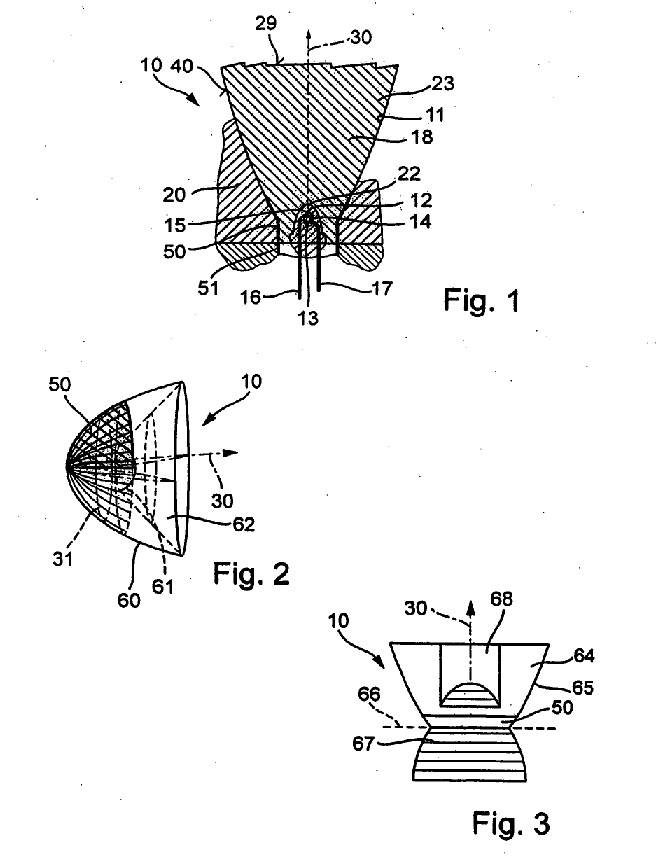

The cross-sectional representation in FIG. 1 sketches the inventive method for producing an LED 10 with an optical waveguide 11. A coating material 51, which will later form a coating 50 of the optical waveguide 11 being produced, is placed in a mold 20 of a tool whose walls have high optical quality, i.e. are very smooth. The coating material 51 is, for example, a transparent film, a metallized film, or even a metal foil or another material described above. The coating material 51 is preferably so thin that it conforms closely to the mold 20 or the walls thereof and that it adheres to the walls in similar fashion to gold leaf.

Furthermore, an LED unit already covered with a material 22 with an electronics casing 12 is inserted. The electronics casing 12 encloses a semiconductor chip 14 as a radiation-emitting emitter mounted on a reflector carrier 13 and an electrical connection 15 in the form of a bond wire and electrical contacts 16, 17 leading to the outside for making electrical contact to the semiconductor chip 14. The LED unit with the electronics casing 12 is molded-in, in the mold 20, by a material 23 that is flowable before final solidification, in particular a highly transparent thermoplastic such as polymethyl methacrylimide (PMMI), polycarbonate (PC), or polymethyl methacrylate (PMMA). To this end, the material 23 enters the mold 20 through openings that are not shown. Such a method is known from the aforementioned DE 101 63 117 C1, the teaching of which is incorporated in full herein by reference. The coating material 51 forms an external coating on the relevant lateral surface of the optical waveguide 11.

The injected material 23 bonds to the electronics casing 12, and after solidification forms a light-guiding body 18, which constitutes a monolithic optical waveguide 11 comprising the LED 10 as a whole, so that after completion no optically disruptive boundary surface is present between the electronics casing 12 and the newly formed light-guiding body 18. Moreover, the coating material 51 embodied as a film also comes into intimate contact with the initially liquid material 23 and, after solidification of the material 23, forms an inner surface to the optical waveguide 11 as a coating 50 with high optical quality. The material 23 settles on the film in this process, presses it against the walls of the mold 20 with high accuracy of form, and thus imparts the walls' high surface quality to the film which forms the coating 50. The coating 50 is monolithically integrated in the optical waveguide 11 through the manufacturing process.

In the finished LED 10, radiation, such as visible light with a defined wavelength or a defined wavelength range, is emitted from the chip 14 and reaches the outside in a primary direction of radiation emission 30 through a primary emergent surface 29. Radiation that is not emitted in the primary direction of radiation emission 30, but instead to the back or side, is reflected at the reflective coating 50 and/or a suitably molded secondary emergent surface 40 until it finally exits the LED 10 through the primary emergent surface 29, significantly increasing the radiant power emitted by the LED 10.

FIG. 2 shows a special embodiment of an LED 10 with an optical waveguide 60.

Parts that remain essentially the same are labeled with the same reference numbers in all figures.

The parabolically molded optical waveguide 60 has a central recess 62 designed as a truncated cone, wherein an emitter (not shown) and electrical contacts (not shown) are arranged beneath the end of the truncated cone. The emitter is located in the focal point of an exit lens 61, which is arranged in the tapering end of the truncated cone. Radiation exits the LED 10 in a primary direction of radiation emission 30 to the truncated end of the optical waveguide 60. The shape of the LED 10 is only sketched. The coating 50 covers only half of the part 31 of the optical waveguide 60 facing away from the emitter, one-sidedly intensifies the reflection of the radiation scattered to the back, and directs this portion in the radiation's primary direction of radiation emission 30. The part 31 facing away can also be provided in its entirety with the coating 50 in the manner of a cap. It is likewise possible to provide only individual segments of the part 31 facing away with the coating 50. For this purpose, an appropriately structured film is placed in the mold 20 described in FIG. 1. The radiation emerging from the LED 10 can then be modulated according to the reflection at the coating 50 on the part 31 facing away.

Optionally the coating 50 can extend to the outer edge of the LED 10 so that the entire coated exterior surface of the optical waveguide 60 is reflective.

FIG. 3 shows a preferred parabolically molded LED 10 with an optical waveguide 65, which optical waveguide has a central, cylindrical recess 68. Here, too, emitter(s) and electrical contacts, which are located somewhat below a separating line 66 between a paraboloidal projection 64, which widens in the primary direction of radiation emission 30, and a lower part 67 of the LED 10, are not shown for the sake of clarity. The lower part 67 of the LED 10 is egg-shaped and is truncated in the center of the egg shape with the pointed end projecting into the recess 68 in the paraboloidal projection 64. A coating 50 surrounds the paraboloidal projection 64 as a narrow strip at the separating line 66. Radiation emerging from the LED 10 is thus focused in the direction of an axis of symmetry of the LED 10 in the primary direction of radiation emission 30. Optionally, the coating 50 can also extend over the lower part 67 and/or the projection 64. The LED 10 can preferably be manufactured in two steps, wherein the lower part 67 is formed first and the upper projection 64 is then placed upon it. The LED 10 can, however, also be manufactured in one or more steps as needed. Bodies with any desired free-form solid shape can be provided as the projection 64; for example it can be conical, pyramidal, spherical, toroidal, or can be composed of a combination of such shapes.

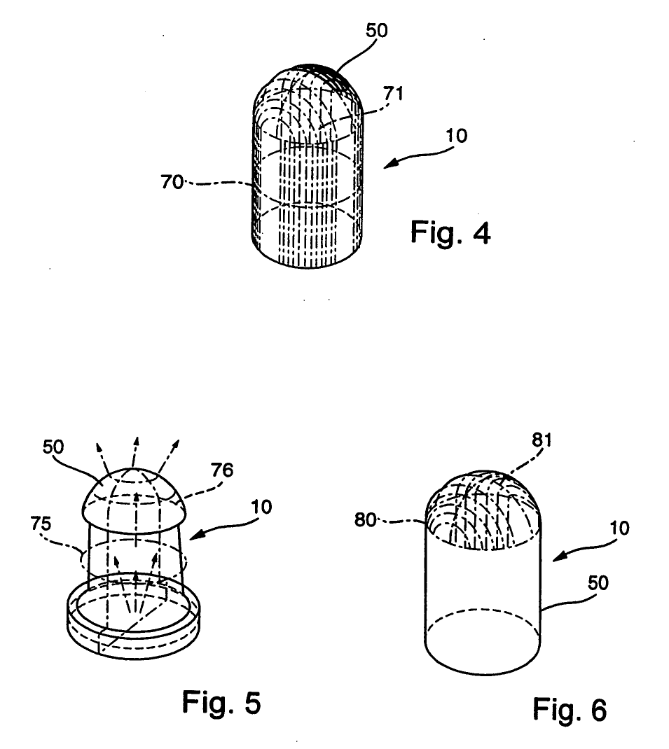

Shown in FIG. 4 is a preferred elliptically molded LED 10 whose optical waveguide 70 is rod-shaped with an elliptical base. The optical waveguide 70 ends in an exit lens 71. Emitter(s) and electrical connections, which are arranged at the end of the optical waveguide 70 opposite the exit lens 72, are not shown. The exit lens 71 has a coating 50 that is opaque to the emitted radiation of the emitter, by which means a precise demarcation between light and dark is achieved for the area illuminated by the emitted radiation. Without the coating 50, the area is essentially fully and uniformly illuminated; with the coating 50, precisely delimited regions in the illuminated area remain unilluminated.

FIG. 5 shows a preferred LED 10 with a cylindrical optical waveguide 75 with a transparent coating 50 containing luminescence-converting additives, for example YAG:Ce, arranged on a radiating surface embodied as an exit lens 76. Here, too, the emitter with contacts located at the end of the optical waveguide 75 opposite the exit lens 76 is not shown. The emitter emits, for example, blue light, which is absorbed by the YAG:Ce luminescence converter or another appropriate luminescence-converting additive and is emitted as yellow light, so that as a whole, white light emerges at the exit lens 71. Through the use of other appropriate additives in the coating 50, any other desired wavelengths may also be emitted.

FIG. 6 shows an LED 10 with a cylindrical optical waveguide 80 with lateral coating 50, which surrounds the optical waveguide 80 such that radiation emerging from the LED 10 can only emerge at its exit lens 81.

In an advantageous further development that is not illustrated, an LED 10 with cylindrical or elliptical optical waveguide can have an opaque coating 50 around the optical waveguide, and its exit lens can have a transparent, luminescence-converting coating, wherein the nontransparent coating surrounds the optical waveguide in its longitudinal extent up to the exit lens. Likewise, a part of the exit lens can be provided with a nontransparent coating as in FIG. 4. Moreover, the positions of transparent and nontransparent coatings can be exchanged so that the LED illuminates along its longitudinal extent and the exit lens is covered.

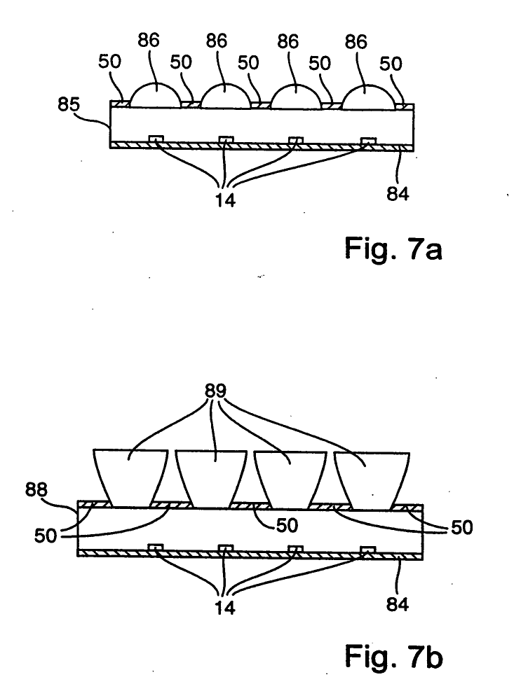

FIG. 7a shows a lateral section through a light module with a plate-shaped optical waveguide 85 with a coating 50 between a plurality of exit lenses 86 arranged over its area. The exit lenses 86 are arranged as a two-dimensional array on the surface of the optical waveguide 85 perpendicular to the plane of the image. The exit lenses 86 may be round. Alternatively, they may have an elliptical base. Other shapes are also possible. The coating 50 serves the purpose of shading and/or reflection of scattering of the radiation emitted by the chips 14. The exit lenses 86 can be microstructured with dimensions of less than 1 mm diameter each, or can also have macroscopic dimensions. A chip-on-board module with a chip array, injection-molded with the optics shown, can be used as the emitter, for example. The chips 14 are arranged on a carrier 84, for example a circuit board, in particular a metallic circuit board.

The optical waveguide 84 is arranged over the chips 14. The chips 14 can, as in the other example embodiments, be provided with bond wires or can be contacted electrically by direct areal contact with the carrier 84. Furthermore, in a favorable further development the exit lenses 86 can be provided at least in part with a transparent coating 50 having luminescence-converting additives (not shown). If the exit lenses 86 are made small enough, a single emitter can also be arranged under multiple exit lenses 86 in an alternative embodiment.

FIG. 7b shows a preferred further development of the two-dimensional array from FIG. 7a. In place of exit lenses 86, an optical waveguide 88 has a preferably paraboloidal projection 89 between the coatings 50 in each case. Bodies with any desired free-form solid shape can be provided as projection 89; for example they can be conical, pyramidal, spherical, hemispherical, toroidal, or can be composed of a combination of such shapes, for example also sections of the shapes in question, for example quarters or eighths of a sphere. Likewise, recesses (not shown) can also be provided in the projections 89, in similar fashion to FIG. 2 or 3. The projections 89 can be oriented in the same direction so that their primary directions of radiation emission are parallel to one another. In a favorable alternative embodiment, however, each of the projections 89 can also be given another orientation in manufacturing by means of an appropriate mold so that their primary directions of radiation emission converge or diverge, or even diverge in some areas and converge in some areas. In this way, a variety of light emission characteristics can be achieved as a function of the chosen orientation of the projections 89. Thus, the emitted radiation can precisely illuminate a rectangle, for example. The chips 14 are again arranged on a carrier 84 on which the optical waveguide 88 is arranged. The chips 14 can again be electrically contacted with or without bond wires.

A preferred manufacture of the optical waveguide 88 advantageously takes place in two steps, wherein the plate-shaped part of the optical waveguide 88 is first manufactured in a mold and is provided in this process with a structured coating 50, and then the mold is exchanged and the projections 89 are added. These, too, can also have a coating 50, for example on their lateral surfaces and/or on their primary emergent surfaces. Of course, the optical waveguide 88 can also be manufactured in a single process step, however.

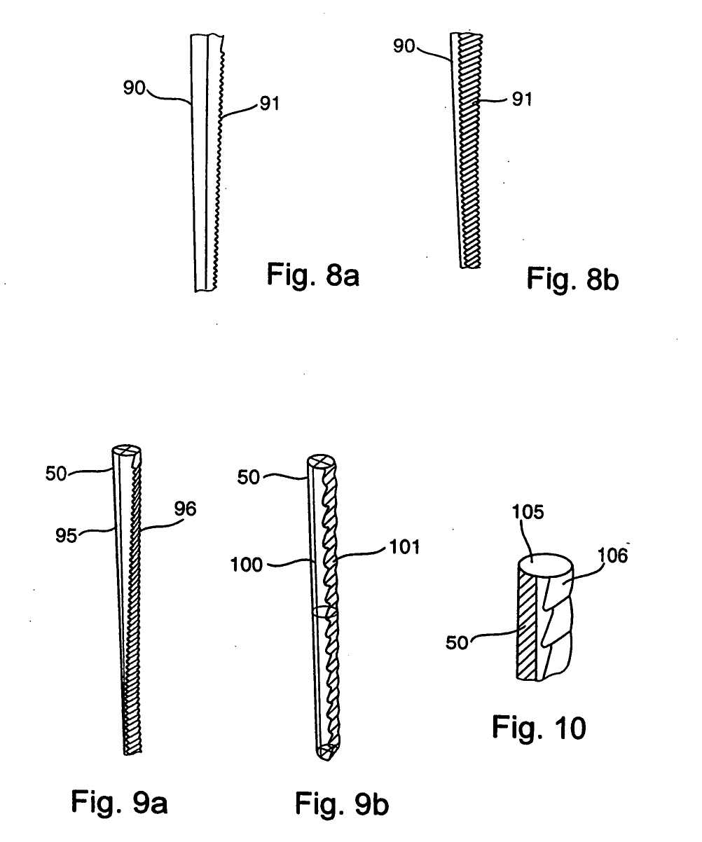

FIGS. 8a and 8b show different views of an optical waveguide 90 embodied as a light pipe. FIG. 8a shows a view of a rear side, and FIG. 8b a view of an emergent surface 91 of the optical waveguide 90. The optical waveguide 90 is provided with emitters (not shown) on one or both of its end faces. A part of its circumference is provided along its longitudinal extent with a sawtooth emergent surface 91. Outside the sawtooth emergent surface 91 on its rear side, the optical waveguide 90 is provided with an opaque coating 50. All of the radiation emitted by the emitter or emitters thus exits from the sawtooth emergent surface 91 with no scattering losses at the rear side of the optical waveguide 90.

FIGS. 9a and 9b illustrate an optical waveguide 95 embodied as a light pipe in a favorable embodiment in which the coating 50 terminates at the teeth of the sawtooth emergent surface 96. This is achieved in that the complete optical waveguide 90 is provided around its circumference with the coating 50 and the emergent surface 96 is then machined, for example milled, out of the optical waveguide 95. By this means, an optical waveguide 95 can be created with an emergent surface 96 that is twisted upon itself and extends not only along the longitudinal extent of the optical waveguide 95, but also around its circumferential direction, as can be seen in FIG. 9a. FIG. 9b shows how the coating 50 extends to teeth of an emergent surface 101 of an optical waveguide 100. In both embodiments in FIGS. 9a and 9b, an emitter can be provided at one of the end faces, or an emitter can be provided at each of the two end faces, with their radiation exiting superimposed at the emergent surface 96 or 101.

FIG. 10 shows a detail of an optical waveguide 105 embodied as a preferred light pipe with a preformed coating 50 which is highlighted by hatching. Here, a coating material 51 can be placed in a mold 20 (FIG. 1) that produces a portion of the lateral surface of the optical waveguide 105. Thus, a sawtooth emergent surface 106 can already be provided in the mold 20 (FIG. 1), so that later machining of the optical waveguide 105 to produce the emergent surface 106 can be omitted. In particular, the emergent surface 106 can be monolithically provided during manufacture with a coating 50 which contains at least one luminescence-converting additive, so that the radiation exiting from the emergent surface 106 is a mixture of radiation emitted from the emitter and from the additive.

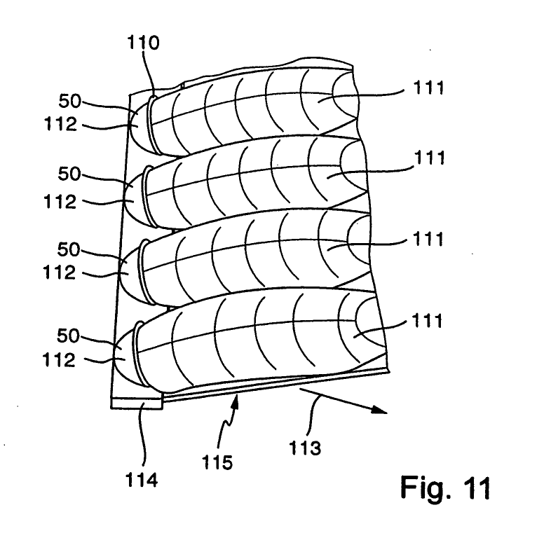

FIG. 11 shows a preferred light module with a preferred optical waveguide 110 with very high luminous efficiency and inclined light emergence. An emitter (not shown) is arranged in each hemispherical part 112 at the end of the finger-like body 111, wherein the emitters are arranged on a common circuit board 114 in the manner of a chip-on-board module. The hemispherical parts 112 are each provided with a nontransparent coating 50, which covers the domed section and its undercuts, so that scattered radiation entering that region is reflected into the finger-like body 111. An emergent surface 115 is located on the underside of the optical waveguide 110 on account of the curvature of the finger-like body 111, and is indicated by an arrow 113. The coating 50 can be in one piece. Alternatively, the coating 50 can be in multiple pieces. Moreover, the optical waveguide 110 can be provided at its emergent side with a transparent coating 50 having luminescence-converting additives.

The inventive optical waveguides 11, 60, 65, 70, 75, 80, 85, 88, 90, 95, 100, 105, 110 preferably find application in lighting units for motor vehicles. These units may be integrated in the car body or also in attached parts for the motor vehicle. Depending on the planned use, the optical waveguides 11, 60, 65, 70, 75, 80, 85, 88, 90, 95, 100, 105, 110 are each provided with one or more coatings 50 appropriate for the application. A suitable LED, made for example of GaAs, GaN, InP, AlInGaP, InAs, Si, Ge, GaP, ZnSe, SiC, ZnS, CdTe and the like, or of organic semiconductors, can be used in each case as the emitter.

A preferred application of the optical waveguide 110 is in a stage of a front headlight for a motor vehicle. It is especially preferred for several such light modules to be combined into a headlight module. In useful fashion, the individual emergent surfaces 115 are covered in certain areas with a nontransparent coating in order to shape the emerging radiation in accordance with regulations concerning the area to be illuminated by a headlight. It is favorable for the primary emergent surfaces 29 to be provided with a transparent coating 50 provided with a luminescence-converting additive, so that a radiation originating from colored emitters and radiation originating from the additive exits the headlight module as white light overall. Of course, the other inventive optical waveguides 11, 60, 65, 70, 75, 80, 85, 88, 90, 95, 100, 105 may also be used alternatively or in addition in a front headlight.

In an advantageous further embodiment, a front headlight has at least one laterally pivotable sidelight unit which comprises one or more of the optical waveguides 11, 60, 65, 70, 75, 80, 85, 88, 90, 95, 100, 105, 110.

In another advantageous further embodiment, the front headlight has one or more of the optical waveguides 11, 60, 65, 70, 75, 80, 85, 88, 90, 95, 100, 105, 110 for a low beam headlight and one or more of the optical waveguides 11, 60, 65, 70, 75, 80, 85, 88, 90, 95, 100, 105, 110 for a high beam headlight.

In another advantageous further embodiment, the front headlight has one or more of the optical waveguides 11, 60, 65, 70, 75, 80, 85, 88, 90, 95, 100, 105, 110 for a parking light. It is also possible for only a few individual LEDs among a number of existing LEDs to be operated for parking illumination of the motor vehicle. This is especially energy-efficient.

In another preferred application, a brake light unit of a motor vehicle has one or more of the optical waveguides 11, 60, 65, 70, 75, 80, 85, 88, 90, 95, 100, 105, 110. The brake light unit can be integrated in a module with other light sources, or can also be integrated in a car body or a vehicle window.

In another preferred application, a turn signal unit of a motor vehicle has one or more of the optical waveguides 11, 60, 65, 70, 75, 80, 85, 88, 90, 95, 100, 105, 110. The turn signal unit can be integrated in the car body, or the turn signal unit can likewise be integrated in an attached part, such as an outside rearview mirror.

In another preferred application, a taillight unit of a motor vehicle has one or more of the optical waveguides 11, 60, 65, 70, 75, 80, 85, 88, 90, 95, 100, 105, 110. In this context, a taillight unit in the region of the bumper can be provided as well as a taillight unit that is integrated in the rear of the vehicle as an additional brake light.

In another preferred application, a fog lamp unit of a motor vehicle has one or more of the optical waveguides 11, 60, 65, 70, 75, 80, 85, 88, 90, 95, 100, 105, 110.

In another preferred application, an interior lamp of the motor vehicle has one or more of the optical waveguides 11, 60, 65, 70, 75, 80, 85, 88, 90, 95, 100, 105, 110.

In another preferred application, a reading lamp unit for the interior of the motor vehicle has one or more of the optical waveguides 11, 60, 65, 70, 75, 80, 85, 88, 90, 95, 100, 105, 110.

In another preferred application, a trunk lighting unit and/or a glove compartment lighting unit of the motor vehicle has one or more of the optical waveguides 11, 60, 65, 70, 75, 80, 85, 88, 90, 95, 100, 105, 110.

In another preferred application, a cargo compartment lighting unit of the motor vehicle, in particular a utility vehicle, has one or more of the optical waveguides 11, 60, 65, 70, 75, 80, 85, 88, 90, 95, 100, 105, 110.

In another preferred application, a trim strip and/or a different decorative element of the motor vehicle has one or more of the optical waveguides 11, 60, 65, 70, 75, 80, 85, 88, 90, 95, 100, 105, 110.

In another preferred application, a signal lamp, for example of a traffic light unit, has one or more of the optical waveguides 11, 60, 65, 70, 75, 80, 85, 88, 90, 95, 100, 105, 110.

In another preferred application, a light source operated by rechargeable battery, for example a flashlight, has one or more of the optical waveguides 11, 60, 65, 70, 75, 80, 85, 88, 90, 95, 100, 105, 110.

1. A method for producing an optical waveguide from a material which is flowable before final solidification, in a mold, comprising, on a first introduction of the said flowable material at least one radiation-emitting emitter with a connecting member electrically contacting the emitter is surrounded by said material thereafter one or more additional introductions of one or more flowable materials take place in a second region located outside of a region of the emitter and the connecting means and monolithically joining a coating comprising a coating material to the optical waveguide during at least one of the introductions.

2. Method according to claim 1, wherein the coating material is placed in the mold at the mold's walls and is joined to the optical waveguide during at least one of the introductions of the flowable material or materials.

3. Method according to claim 2, wherein the coating material is placed in a region of the mold in which is formed a part of the optical waveguide facing away from a primary direction of radiation emission of the optical waveguide.

4. Method according to claim 2, wherein the coating material is placed in a region of the mold in which is formed an essentially parallel part of the optical waveguide with respect to a primary direction of radiation emission of the optical waveguide.

5. Method according to claim 2, wherein the coating material is placed in a region of the mold in which at least part of a primary direction of radiation emission of the optical waveguide is formed.

6. An optical waveguide comprising an optical waveguide of a material which is flowable before final solidification, wherein at least one light-emitting chip with its connecting means electrically contacting the chip are surrounded by this material, and one or more flowable materials are applied to regions located outside the chip and the connecting means by one or more additional introductions, wherein a coating is monolithically integrated in the optical waveguide.

7. Optical waveguide according to claim 6, wherein the coating is provided in a part of the optical waveguide facing away from a primary direction of radiation emission of the optical waveguide.

8. Optical waveguide according to claim 6, wherein the coating is provided in an essentially parallel part of the optical waveguide with respect to the primary direction of radiation emission of the optical waveguide.

9. Optical waveguide according to claim 6, wherein the coating is arranged in at least one part of a primary direction of radiation emission of the optical waveguide.

10. Optical waveguide according to claim 6, wherein the coating is designed to be reflective toward the optical waveguide for a wavelength range of the radiation emitted by the LED.

11. Optical waveguide according to claim 10, wherein the coating is opaque for the wavelength range.

12. Optical waveguide according to claim 6, wherein the coating is transparent for a wavelength range of the emitted radiation of the LED.

13. Optical waveguide according to claim 6, wherein a plastic film is provided as the coating material of the coating.

14. Optical waveguide according to claim 6, wherein a metallized plastic film is provided as the coating material of the coating.

15. Optical waveguide according to claim 6, wherein a metal foil is provided as the coating material of the coating.

16. Optical waveguide according to claim 13, wherein the coating has a thickness such that the film is self-adhering.

17. Optical waveguide according to claim 13, wherein the coating has silicone or a silicone-containing material.

18. A method for producing an optical waveguide in a mold comprising,
providing at least one radiation emitting emitter and an electrical connection attached thereto,
introducing a material which is flowable before final solidification into said mold in a region surrounding said emitter,
providing one or more additional introductions of one or more flowable materials in at least one region outside of said region surrounding said emitter and,
monolithically joining a coating material to the optical waveguide during at least one of said introductions of flowable material.
